(19) United States
(12) Patent Application Publication
(10) Pub. No.: US 2008/0169183 A1
(43) Pub. Date: Jul. 17, 2008

(54) Plasma Source with Liner for Reducing Metal Contamination

(75) Inventors: Richard J. Hertel, Boxford, MA (US); You Chia Li, Reading, MA (US); Philip J. McGrail, Northwood, NH (US); Timothy J. Miller, Ipswich, MA (US); Harold M. Persing, Westbrook, ME (US); Vikram Singh, North Andover, MA (US)

Correspondence Address: RAUSCHENBACH PATENT LAW GROUP, LLC, P.O. BOX 387, BEDFORD, MA, 01730, US

(73) Assignee: VARIAN SEMICONDUCTOR EQUIPMENT ASSOCIATES, INC., Gloucester, MA (US)

(21) Appl. No.: 11/623,739

(22) Filed: Jan. 16, 2007

(51) Int. Cl. H05F 3/00

(52) U.S. Cl. 204/164; 118/723 I

(57) ABSTRACT

A plasma source having a plasma chamber with metal chamber walls contains a process gas. A dielectric window passes a RF signal into the plasma chamber. The RF signal excites and ionizes the process gas, thereby forming a plasma in the plasma chamber. A plasma chamber liner that is positioned inside the plasma chamber provides line-of-site shielding of the inside of the plasma chamber from metal sputtered by ions striking the metal walls of the plasma chamber.

The section headings used herein are for organizational purposes only and should not to be construed as limiting the subject matter described in the present application.

### BACKGROUND OF THE INVENTION

Conventional beam-line ion implanters accelerate ions with an electric field. The accelerated ions are filtered according to their mass-to-charge ratio to select the desired ions for implantation. Recently plasma doping systems have been developed to meet the doping requirements of some modern electronic and optical devices. Plasma doping is sometimes referred to as PLAD or plasma immersion ion implantation (PIII). These plasma doping systems immerse the target in a plasma containing dopant ions and bias the target with a series of negative voltage pulses. The electric field within the plasma sheath accelerates ions toward the target which implants the ions into the target surface.

Plasma doping systems typically include plasma chambers that are made of aluminum because aluminum is resistant to many process gasses and because aluminum can be easily formed and machined into the desired shapes. Many plasma doping systems also include Al₂O₃ dielectric windows for passing RF and microwave signals from external antennas into the plasma chamber. The presence of the aluminum and the aluminum based materials can result in metal contaminating the substrate being doped.

### BRIEF DESCRIPTION OF THE DRAWINGS

The aspects of this invention may be better understood by referring to the following description in conjunction with the accompanied drawings, in which like numerals indicate like structural elements and features in various figures. The drawings are not necessarily to scale. A skilled artisan will understand that the drawings, described below, are for illustration purposes only. The drawings are not intended to limit the scope of the present teachings in any way.

FIG. 1 illustrates one embodiment of a RF plasma source including a plasma chamber liner according the present invention.

FIG. 2 illustrates a drawing of a one-piece or unitary plasma chamber liner according to the present invention that provides line-of-site shielding between the chamber walls and the inside of the chamber.

FIG. 3 illustrates a drawing of a segmented plasma chamber liner according to the present invention that provides line-of-site shielding between the plasma chamber walls and the inside of the plasma chamber.

FIG. 4 illustrates a drawing of a temperature controlled plasma chamber liner according to the present invention that provides both line-of-site shielding between the plasma chamber walls and the inside of the plasma chamber and control over the temperature distribution on the inner surface of the plasma chamber liner.

### DETAILED DESCRIPTION

While the present teachings are described in conjunction with various embodiments and examples, it is not intended that the present teachings be limited to such embodiments. On the contrary, the present teachings encompass various alternatives, modifications and equivalents, as will be appreciated by those of skill in the art.

For example, although the plasma chamber liners of the present invention are described in connection with reducing metal contamination in plasma doping apparatus, the plasma chamber liners of the present invention can be used to reduce metal contamination in many types of processing apparatus including, but not limited to, various types of etching and deposition systems.

It should be understood that the individual steps of the methods of the present invention may be performed in any order and/or simultaneously as long as the invention remains operable. Furthermore, it should be understood that the apparatus of the present invention can include any number or all of the described embodiments as long as the invention remains operable.

Metal contamination can introduce unwanted impurities into substrates being doped with plasma doping systems. Any metal inside of a plasma chamber is potentially a source of metal contamination. It is known in the art that aluminum contamination can result from sputtering of aluminum plasma chamber walls. Aluminum is commonly used as a base metal for many plasma chambers. Aluminum contamination can also result from sputtering of Al₂O₃ dielectric material, which is commonly used to form dielectric windows and other structures within plasma chambers.

Sputtering occurs because RF antennas, and other electrodes, forming the plasma apply relatively high voltages inside the plasma reactor. These high voltages accelerate the ions in the plasma to relatively high energy levels. The resulting energetic ions strike the aluminum base material and the Al₂O₃ dielectric material and consequently dislodge aluminum atoms and Al₂O₃ molecules. The dislodged aluminum atoms and Al₂O₃ molecules strike the substrate being doped causing at least some concentration of unwanted metal dopants.

It is generally desirable to reduce aluminum and Al₂O₃ contamination in plasma immersion ion implantation processes to an areal density of less than 5×10¹¹/cm². However, many PLAD implantation processes using known plasma reactors, and using BF₃ and AsH₃, result in aluminum and Al₂O₃ areal densities that are significantly greater than 5×10¹¹/cm².

One aspect of the present invention relates to a plasma doping system with structures that provide line-of-site shielding between the plasma chamber walls (and ports within the chamber) and the inside of the chamber. In one embodiment, line-of-sight shielding is accomplished with a specially designed plasma chamber liner that provides a barrier to sputtered material. Using the specially designed plasma chamber liner of the present invention can prevent any significant metal contamination in the plasma doping process. In particular, using the specially designed plasma chamber liner of the present invention can prevent any significant aluminum contamination in substrates being processed by plasma doping apparatus with aluminum chambers.

The plasma chamber liners of the present invention can be constructed to be compatible with all known plasma doping processes including plasma doping processes that use diborance, BF3, and AsH3 dopant gases. In addition, the chamber liners of the present invention work with various types of discharges, such as RF and glow discharge sources.

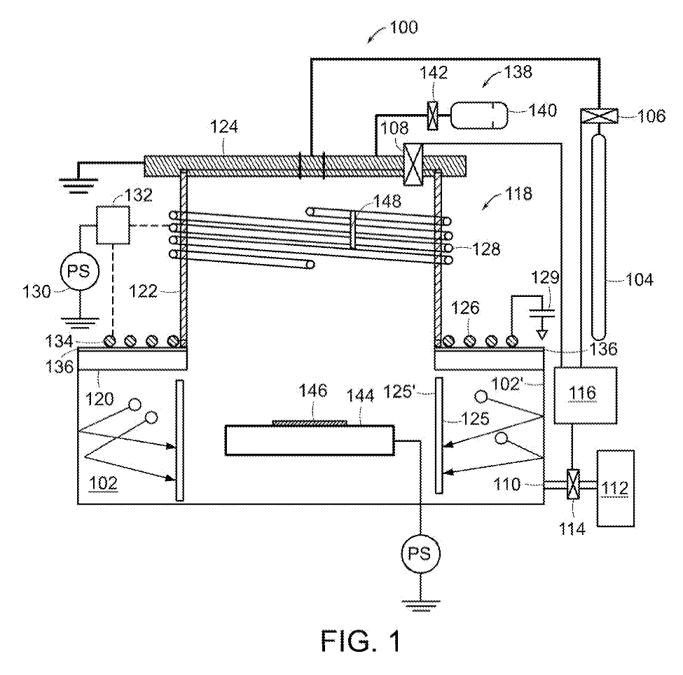

FIG. 1 illustrates one embodiment of a RF plasma source 100 including a plasma chamber liner according the present invention. The plasma source 100 is an inductively coupled plasma source that includes both a planar and a helical RF coil and a conductive top section. A similar RF inductively coupled plasma source is described in U.S. patent application Ser. No. 10/905,172, filed on Dec. 20, 2004, entitled “RF Plasma Source with Conductive Top Section,” which is assigned to the present assignee. The entire specification of U.S. patent application Ser. No. 10/905,172 is incorporated herein by reference. The plasma source 100 is well suited for PLAD applications because it can provide a highly uniform ion flux and the source also efficiently dissipates heat generated by secondary electron emissions.

More specifically, the plasma source 100 includes a plasma chamber 102 that contains a process gas supplied by an external gas source 104. The external gas source 104, which is coupled to the plasma chamber 102 through a proportional valve 106, supplies the process gas to the chamber 102. In some embodiments, a gas baffle is used to disperse the gas into the plasma source 102. A pressure gauge 108 measures the pressure inside the chamber 102. An exhaust port 110 in the chamber 102 is coupled to a vacuum pump 112 that evacuates the chamber 102. An exhaust valve 114 controls the exhaust conductance through the exhaust port 110.

A gas pressure controller 116 is electrically connected to the proportional valve 106, the pressure gauge 108, and the exhaust valve 114. The gas pressure controller 116 maintains the desired pressure in the plasma chamber 102 by controlling the exhaust conductance and the process gas flow rate in a feedback loop that is responsive to the pressure gauge 108. The exhaust conductance is controlled with the exhaust valve 114. The process gas flow rate is controlled with the proportional valve 106.

In some embodiments, a ratio control of trace gas species is provided to the process gas by a mass flow meter that is coupled in-line with the process gas that provides the primary dopant gas species. Also, in some embodiments, a separate gas injection means is used for in-situ conditioning species. Furthermore, in some embodiments, a multi-port gas injection means is used to provide gases that cause neutral chemistry effects that result in across substrate variations.

The chamber 102 has a chamber top 118 including a first section 120 formed of a dielectric material that extends in a generally horizontal direction. A second section 122 of the chamber top 118 is formed of a dielectric material that extends a height from the first section 120 in a generally vertical direction. The first and second sections 120, 122 are sometimes referred to herein generally as the dielectric window. It should be understood that there are numerous variations of the chamber top 118. For example, the first section 120 can be formed of a dielectric material that extends in a generally curved direction so that the first and second sections 120, 122 are not orthogonal as described in U.S. patent application Ser. No. 10/905,172, which is incorporated herein by reference. In other embodiment, the chamber top 118 includes only a planer surface.

The shape and dimensions of the first and the second sections 120, 122 can be selected to achieve a certain performance. For example, one skilled in the art will understand that the dimensions of the first and the second sections 120, 122 of the chamber top 118 can be chosen to improve the uniformity of plasmas. In one embodiment, a ratio of the height of the second section 122 in the vertical direction to the length across the second section 122 in the horizontal direction is adjusted to achieve a more uniform plasma. For example, in one particular embodiment, the ratio of the height of the second section 122 in the vertical direction to the length across the second section 122 in the horizontal direction is in the range of 1.5 to 5.5.

The dielectric materials in the first and second sections 120, 122 provide a medium for transferring the RF power from the RF antenna to a plasma inside the chamber 102. In one embodiment, the dielectric material used to form the first and second sections 120, 122 is a high purity ceramic material that is chemically resistant to the process gases and that has good thermal properties. For example, in some embodiments, the dielectric material is 99.6% Al₂O₃ or AlN. In other embodiments, the dielectric material is Yittria and YAG.

A lid 124 of the chamber top 118 is formed of a conductive material that extends a length across the second section 122 in the horizontal direction. In many embodiments, the conductivity of the material used to form the lid 124 is high enough to dissipate the heat load and to minimize charging effects that results from secondary electron emission. Typically, the conductive material used to form the lid 124 is chemically resistant to the process gases. In some embodiments, the conductive material is aluminum or silicon.

The lid 124 can be coupled to the second section 122 with a halogen resistant O-ring made of fluoro-carbon polymer, such as an O-ring formed of Chemrz and/or Kalrex materials. The lid 124 is typically mounted to the second section 122 in a manner that minimizes compression on the second section 122, but that provides enough compression to seal the lid 124 to the second section. In some operating modes, the lid 124 is RF and DC grounded as shown in FIG. 1.

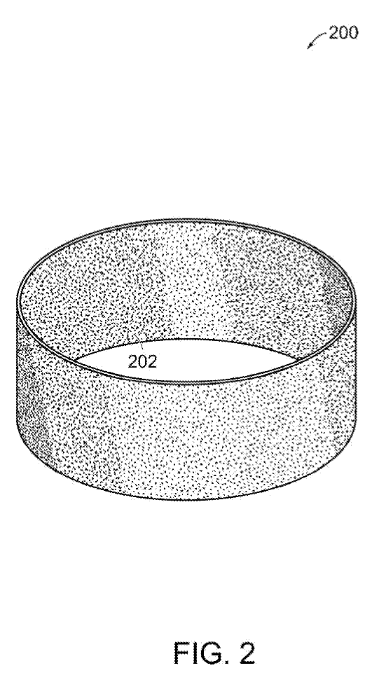

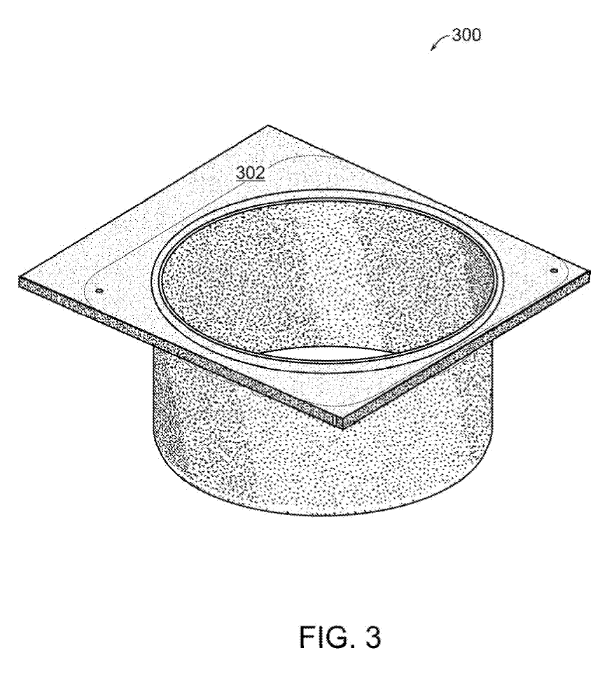

Plasma sources according to the present invention include a plasma chamber liner 125. The plasma chamber liner 125 is positioned to prevent or greatly reduce metal contamination by providing line-of-site shielding of the inside of the plasma chamber 102 from metal sputtered by ions in the plasma striking the inside metal walls 102′ of the plasma chamber 102 as described herein. The plasma chamber liner 125 can be a one piece or unitary plasma chamber liner as described in connection with FIG. 2 or can be a segmented plasma chamber liner as described in connection with FIG. 3. In many embodiments, the plasma chamber liner 125 is formed of a metal base material, such as aluminum. In these embodiments, at least the inner surface 125′ of the plasma chamber liner 125 includes a hard coating material that prevents sputtering of the plasma chamber liner base material as described herein.

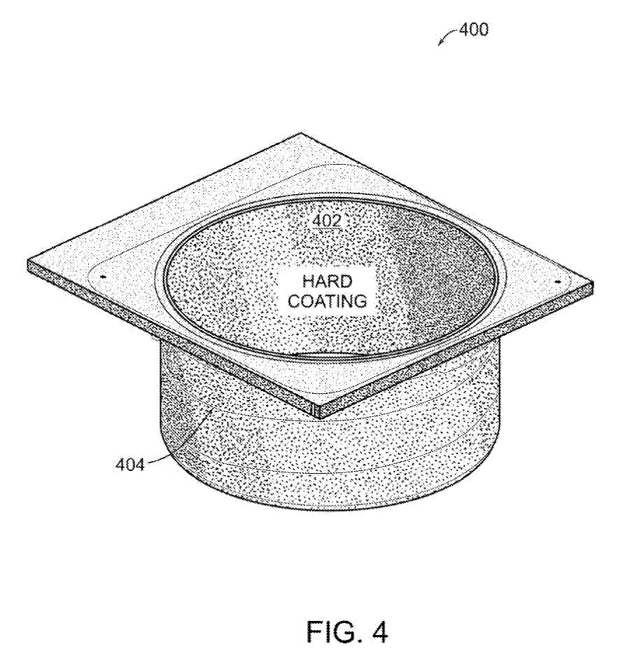

Some plasma doping processes generate a considerable amount of non-uniformly distributed heat on the inner surfaces of the plasma source 100 because of secondary electron emissions. In some embodiments, the plasma chamber liner 125 is a temperature controlled plasma chamber liner 125 as described in connection with FIG. 4. In addition, in some embodiments, the lid 124 comprises a cooling system that regulates the temperature of the lid 124 and surrounding area in order to dissipate the heat load generated during processing. The cooling system can be a fluid cooling system that includes cooling passages in the lid 124 that circulate a liquid coolant from a coolant source.

A RF antenna is positioned proximate to at least one of the first section 120 and the second section 122 of the chamber top 118. The plasma source 100 in FIG. 1 illustrates two separate RF antennas that are electrically isolated from one another. However, in other embodiments, the two separate RF antennas are electrically connected. In the embodiment shown in FIG. 1, a planar coil RF antenna 126 (sometimes called a planar antenna or a horizontal antenna) having a plurality of turns is positioned adjacent to the first section 120 of the chamber top 118. In addition, a helical coil RF antenna 128 (sometimes called a helical antenna or a vertical antenna) having a plurality of turns surrounds the second section 122 of the chamber top 118.

In some embodiments, at least one of the planar coil RF antenna 126 and the helical coil RF antenna 128 is terminated with a capacitor 129 that reduces the effective antenna coil voltage. The term “effective antenna coil voltage” is defined herein to mean the voltage drop across the RF antennas 126, 128. In other words, the effective coil voltage is the voltage “seen by the ions” or equivalently the voltage experienced by the ions in the plasma.

Also, in some embodiments, at least one of the planar coil RF antenna 126 and the helical coil RF antenna 128 includes a dielectric layer 134 that has a relatively low dielectric constant compared to the dielectric constant of the Al₂O₃ dielectric window material. The relatively low dielectric constant dielectric layer 134 effectively forms a capacitive voltage divider that also reduces the effective antenna coil voltage. In addition, in some embodiments, at least one of the planar coil RF antenna 126 and the helical coil RF antenna 128 includes a Faraday shield 136 that also reduces the effective antenna coil voltage.

A RF source 130, such as a RF power supply, is electrically connected to at least one of the planar coil RF antenna 126 and helical coil RF antenna 128. In many embodiments, the RF source 130 is coupled to the RF antennas 126, 128 by an impedance matching network 132 that matches the output impedance of the RF source 130 to the impedance of the RF antennas 126, 128 in order to maximize the power transferred from the RF source 130 to the RF antennas 126, 128. Dashed lines from the output of the impedance matching network 132 to the planar coil RF antenna 126 and the helical coil RF antenna 128 are shown to indicate that electrical connections can be made from the output of the impedance matching network 132 to either or both of the planar coil RF antenna 126 and the helical coil RF antenna 128.

In some embodiments, at least one of the planar coil RF antenna 126 and the helical coil RF antenna 128 is formed such that it can be liquid cooled. Cooling at least one of the planar coil RF antenna 126 and the helical coil RF antenna 128 will reduce temperature gradients caused by the RF power propagating in the RF antennas 126, 128.

In some embodiments, the plasma source 100 includes a plasma igniter 138. Numerous types of plasma igniters can be used with the plasma source apparatus of the present invention. In one embodiment, the plasma igniter 138 includes a reservoir 140 of strike gas, which is a highly-ionizable gas, such as argon (Ar), which assists in igniting the plasma. The reservoir 140 is coupled to the plasma chamber 102 with a high conductance gas connection. A burst valve 142 isolates the reservoir 140 from the process chamber 102. In another embodiment, a strike gas source is plumbed directly to the burst valve 142 using a low conductance gas connection. In some embodiments, a portion of the reservoir 140 is separated by a limited conductance orifice or metering valve that provides a steady flow rate of strike gas after the initial high-flow-rate burst.

A platen 144 is positioned in the process chamber 102 a height below the top section 118 of the plasma source 102. The platen 144 holds a substrate 146 for plasma doping. In many embodiments, the substrate 146 is electrically connected to the platen 144. In the embodiment shown in FIG. 1, the platen 144 is parallel to the plasma source 102. However, in one embodiment of the present invention, the platen 144 is tilted with respect to the plasma source 102.

A platen 144 is used to support a substrate 146 or other workpieces for processing. In some embodiments, the platen 144 is mechanically coupled to a movable stage that translates, scans, or oscillates the substrate 146 in at least one direction. In one embodiment, the movable stage is a dither generator or an oscillator that dithers or oscillates the substrate 146. The translation, dithering, and/or oscillation motions can reduce or eliminate shadowing effects and can improve the uniformity of the ion beam flux impacting the surface of the substrate 146.

In some embodiments, a deflection grid is positioned in the chamber 102 proximate to the platen 144. The deflection grid is a structure that forms a barrier to the plasma generated in the plasma source 102 and that also defines passages through which the ions in the plasma pass through when the grid is properly biased.

One skilled in the art will appreciate that the there are many different possible variations of the plasma source 100 that can be used with the features of the present invention. See for example, the descriptions of the plasma sources in U.S. patent application Ser. No. 10/908,009, filed Apr. 25, 2005, entitled “Tilted Plasma Doping.” Also see the descriptions of the plasma sources in U.S. patent application Ser. No. 11/163,303, filed Oct. 13, 2005, entitled “Conformal Doping Apparatus and Method.” Also see the descriptions of the plasma sources in U.S. patent application Ser. No. 11/163,307, filed Oct. 13, 2005, entitled “Conformal Doping Apparatus and Method.” In addition, see the descriptions of the plasma sources in U.S. patent application Ser. No. 11/566,418, filed Dec. 4, 2006, entitled “Plasma Doping with Electronically Controllable Implant Angle.” The entire specification of U.S. patent application Ser. Nos. 10/908,009, 11/163,303, 11/163,307 and 11/566,418 are herein incorporated by reference.

In operation, the RF source 130 generates RF currents that propagate in at least one of the RF antennas 126 and 128. That is, at least one of the planar coil RF antenna 126 and the helical coil RF antenna 128 is an active antenna. The term “active antenna” is herein defined as an antenna that is driven directly by a power supply. The RF currents in the RF antennas 126, 128 then induce RF currents into the chamber 102. The RF currents in the chamber 102 excite and ionize the process gas so as to generate a plasma in the chamber 102. The plasma chamber liner 125 shields metal sputtered by ions in the plasma from reaching the substrate 146. The plasma sources 100 can operate in either a continuous mode or a pulsed mode.

In some embodiments, one of the planar coil antenna 126 and the helical coil antenna 128 is a parasitic antenna. The term “parasitic antenna” is defined herein to mean an antenna that is in electromagnetic communication with an active antenna, but that is not directly connected to a power supply. In other words, a parasitic antenna is not directly excited by a power supply, but rather is excited by an active antenna. In some embodiments of the invention, one end of the parasitic antenna is electrically connected to ground potential in order to provide antenna tuning capabilities. In this embodiment, the parasitic antenna includes a coil adjuster 148 that is used to change the effective number of turns in the parasitic antenna coil. Numerous different types of coil adjusters, such as a metal short, can be used.

FIG. 2 illustrates a drawing of a one-piece or unitary plasma chamber liner 200 according to the present invention that provides line-of-site shielding between the plasma chamber walls and the inside of the plasma chamber. Referring to both FIGS. 1 and 2, the unitary plasma chamber liner 200 is positioned inside the plasma chamber 102 adjacent to the inner walls 102′ of the plasma chamber 102. In one embodiment, the plasma chamber liner 200 is formed of an aluminum base material, or some other easily formable material, that is resistant to the desired dopant and/or other process gasses. Aluminum is widely accepted in the industry and is generally desirable for many applications. Aluminum is also a good thermal conductor. Therefore, using aluminum will improve heat dissipation in the plasma chamber. In some embodiments, the plasma chamber liner 200 is specifically shaped to improve heat dissipation. In these embodiments, the plasma chamber liner 200 can include structures that increase heat dissipation.

The unitary plasma chamber liner 200 can be machined from solid stock material, such as a solid piece of aluminum. In some embodiments, the unitary plasma chamber liner 200 is physically attached to the plasma chamber 102 with a fastener. The unitary plasma chamber liner 200 can be bolted directly to the plasma chamber 200 in numerous ways. For example, the unitary plasma chamber liner 200 can be bolted directly to the bottom of the plasma chamber 102.

In many embodiments, the plasma chamber liner base material is coated with a hard coating. In some embodiments, the entire plasma chamber liner is coated with the hard coating. In other embodiments, only the inner surface 202 of the plasma chamber liner 200 is coated with the hard coating material. There are numerous possible hard coatings that are suitable for plasma chamber liners according to the present invention. The hard coating material is typically chosen so that there is no significant sputtering of the hard coating material during the plasma doping process. In some embodiments, the hard coating material is chosen to enhance heat dissipation.

For example, in some embodiments, the plasma chamber liner base material is coated with a diamond like coating, Si, SiC, or a Y₂O₃ coating. In other embodiments, the plasma chamber liner 200 base material is anodized. For example, an aluminum plasma chamber liner can be anodized to form a coating of anodized aluminum.

Plasma chambers often include ports for various purposes, such as providing access for diagnostic equipment. In some embodiments, liners are inserted into at least one port within the plasma chamber 102. The port liner provide line-of-site shielding of the inner surfaces of the plasma chamber from metal sputtered by ions in the plasma striking the at least one port. The port liners can be fabricated from solid stock or from multiple segments of metal, such as aluminum. At least the inner surfaces of the port liners are coated with a hard coating. The port liners can be installed from the inside of the plasma chamber 102 or from the outside of the plasma chamber 102.

FIG. 3 illustrates a drawing of a segmented plasma chamber liner 300 according to the present invention that provides line-of-site shielding between the plasma chamber walls and the inside of the plasma chamber. In one embodiment, the segmented plasma chamber liner 300 of the present invention includes a plurality of segments of metal, such as aluminum or some other formable material. The plurality of segments of metal can be attached by various means. For example, in some embodiments, the plurality of segments is welded together. In other embodiments, the plurality of segments is attached with fasteners, such as bolts or pins. The segmented plasma chamber liner 300 can be easier and less expensive to manufacture in some commercial embodiments.

Referring to both FIGS. 1 and 3, in one embodiment, the plurality of segments is fabricated from multiple machined components that are integrated into a spacer plate 302. The spacer plate 302 is attached to the top of the plasma chamber liner 300. The spacer plate 302 allows the plasma chamber liner 300 to be easily positioned in the plasma chamber 102. The spacer plate 302 can be designed to center the plasma chamber liner 300 in the plasma chamber 102. For example, the spacer plate 300 can include features that match features in the plasma chamber 102 so as to self-align the plasma chamber liner 300 to the plasma chamber 102.

In many embodiments, at least one of the segments in the segmented plasma chamber liner 300 is coated with a hard coating. In some embodiments, only the inner surfaces of the segmented plasma chamber liner 300 are coated with the hard coating material. In other embodiments, all surfaces of each of the plurality of segments are coated with a hard coating. There are numerous possible hard coatings that are suitable for segmented plasma chamber liners according to the present invention. For example, in some embodiments, the segmented plasma chamber liner base material is coated with a diamond like coating, Si, SiC, or a Y₂O₃ coating. In other embodiments, the segmented plasma chamber liner 300 base material is anodized. For example, an aluminum plasma chamber liner base material can be anodized to form a coating of anodized aluminum.

FIG. 4 illustrates a drawing of a temperature controlled plasma chamber liner according to the present invention that provides both line-of-site shielding between the plasma chamber walls and the inside of the plasma chamber and control over the temperature distribution on the inner surface of the liner. One feature of the plasma chamber liner of the present invention is that it can include cooling passages that control the temperature distribution of the inner surface 402 of the plasma chamber liner 400 which is exposed to the plasma. The temperature controlled plasma chamber liner 400 can be a unitary plasma chamber liner as described in connection with FIG. 2 or can be a segmented chamber liner as described in connection with FIG. 3. That is, the temperature controlled plasma chamber liner 400 can be formed from one piece of material or can be formed from a plurality of segments.

In many embodiments, the temperature controlled plasma chamber liner 400 is coated with a hard coating. In some embodiments, only the inner surface 402 of the temperature controlled plasma chamber liner 400 is coated with the hard coating material. In other embodiments, the entire temperature controlled plasma chamber liner 400 is coated with a hard coating. There are numerous possible hard coatings that are suitable for the temperature controlled chamber liners according to the present invention as described herein. For example, in some embodiments, the temperature controlled plasma chamber liner base material is coated with a diamond like coating, Si, SiC, or a Y₂O₃ coating. In other embodiments, the temperature controlled plasma chamber liner 400 base material is anodized.

In addition, the temperature controlled plasma chamber liner 400 includes internal cooling passages 404 that are conduits formed inside of the temperature controlled plasma chamber liner 400. These cooling passages 404 can be machined directly into the liner 400. One skilled in the art will appreciate that there are many ways of forming these internal cooling passages, such as machining, drill, and etching.

In one particular embodiment, internal cooling passages 404 are machined in a helical pattern. In this embodiment, the pitch of the helix can be varied to compensate for certain irregularities in the thermal input. For example, a shorter pitch can be used when it is desirable to extract heat from areas that are adjacent to relatively high heat input. A taller pitch can be used when it is desirable to extract heat from areas that are adjacent to relatively low heat input. The temperature controlled plasma chamber liner 400 can be formed in multiple sections to simplify forming the internal passages.

In one embodiment, the cooling passages 404 control the temperature distribution of the inner surface 402 of the temperature controlled plasma chamber liner 400 so that the inner surface 402 of the liner 400 has an approximately uniform temperature distribution. In general, the heat flow from the plasma to the inner surface 402 of the liner 400 is not uniform. However, it is desirable for some applications to have a uniform temperature distribution on the inner surface 402 of the liner 400. For example, a uniform temperature distribution on the inner surface 402 of the liner 400 can improve the uniformity of the plasma and thus can improve the uniformity of a plasma doping process or other process. In one specific embodiment, the cooling passages 404 control the temperature distribution of the inner surface 402 of the liner 400 so that the inner surface 402 of the liner 400 is maintained at a particular desired temperature.

In another embodiment, the cooling passages 404 control the temperature distribution of the inner surface 402 of the temperature controlled plasma chamber liner 400 so that the inner surface 402 of the liner 400 has a predetermined non-uniform temperature distribution. There are some applications where it is desirable for the liner 400 to have a non-uniform temperature distribution in a certain localized area. For example, the temperature distribution of the liner 400 can be selected to achieve a certain non-uniform temperature distribution that is selected to cool certain localized areas of the inner surface 402 of the liner 400 to relatively low temperatures. These localized areas of the inner surface 402 with relatively low temperatures can compensate of certain plasma non-uniformities so as to improve the overall uniformity of the plasma.

### EQUIVALENTS

While the present teachings are described in conjunction with various embodiments and examples, it is not intended that the present teachings be limited to such embodiments. On the contrary, the present teachings encompass various alternatives, modifications and equivalents, as will be appreciated by those of skill in the art, may be made therein without departing from the spirit and scope of the invention as defined by the appended claims.

What is claimed is:

1. A plasma source comprising:
a) a plasma chamber having metal chamber walls, the plasma chamber containing a process gas inside the plasma chamber;
b) a dielectric window that passes a RF signal into the plasma chamber, the RF signal electromagnetically coupling into the plasma chamber to excite and ionize the process gas, thereby forming a plasma in the plasma chamber; and
c) a plasma chamber liner that is positioned inside the plasma chamber, the plasma chamber liner providing line-of-site shielding of the inside of the plasma chamber from metal sputtered by ions striking the metal walls of the plasma chamber.

2. The plasma source of claim 1 wherein the plasma chamber liner comprises a unitary liner.

3. The plasma source of claim 1 wherein the plasma chamber liner comprises a plurality of segments.

4. The plasma source of claim 1 wherein the plasma chamber is formed of aluminum.

5. The plasma source of claim 1 wherein the plasma chamber liner is formed of an aluminum base metal with a hard coating.

6. The plasma source of claim 1 wherein the plasma chamber liner is shaped to enhance heat dissipation.

7. The plasma source of claim 1 wherein the plasma chamber liner comprises a hard coating on an inner surface.

8. The plasma source of claim 1 wherein the plasma chamber liner comprises a hard coating on all surfaces.

9. The plasma source of claim 8 wherein the hard coating comprises a diamond like coating.

10. The plasma source of claim 8 wherein the hard coating comprises an anodized coating.

11. The plasma source of claim 8 wherein the hard coating comprises at least one of a Si, SiC, or a Y₂O₃ hard coating.

12. The plasma source of claim 1 wherein the plasma chamber liner is fastened to the plasma chamber.

13. The plasma source of claim 1 wherein the plasma chamber liner further comprises a spacer plate.

14. The plasma source of claim 13 wherein the spacer plate self-aligns the plasma chamber liner within the plasma chamber.

15. The plasma source of claim 1 wherein the plasma chamber comprises at least one port that includes a port liner, the port liner providing line-of-site shielding of the inner surfaces of the plasma chamber from metal sputtered by ions in the plasma striking the at least one port.

16. A plasma source comprising:
a) a plasma chamber having metal chamber walls, the plasma chamber containing a process gas inside the plasma chamber;
b) a dielectric window that passes a RF signal into the plasma chamber, the RF signal electromagnetically coupling into the plasma chamber to excite and ionize the process gas, thereby forming a plasma in the plasma chamber; and
c) a plasma chamber liner comprising at least one cooling passage that controls a temperature of the plasma chamber liner, the plasma chamber liner being positioned inside the plasma chamber so as to provide line-of-site shielding of the inside of the plasma chamber from metal sputtered by ions striking the metal walls of the plasma chamber.

17. The plasma source of claim 16 wherein the at least one cooling passage comprises at least one internal cooling passage formed within the plasma chamber liner.

18. The plasma source of claim 16 wherein the at least one cooling passage comprises at least one external cooling passage that is at least partially formed on an outer surface of the plasma chamber liner.

19. The plasma source of claim 16 wherein the at least one cooling passage comprises a water cooling passage.

20. The plasma source of claim 16 wherein the at least one cooling passage is formed in a helical shape.

21. The plasma source of claim 20 wherein a pitch of the helical shape is not constant.

22. The plasma source of claim 20 wherein a pitch of at least a portion of the helical shape is selected to provide a desired localized heat transfer.

23. The plasma source of claim 20 wherein a pitch of at least a portion of the helical shape is chosen to maintain an approximately constant temperature on at least a portion of an inner surface of the liner.

24. The plasma source of claim 20 wherein a pitch of at least a portion of the helical shape is chosen to provide a predetermined temperature distribution on at least a portion of an inner surface of the liner.

25. The plasma source of claim 16 wherein the plasma chamber liner comprises a unitary liner.

26. The plasma source of claim 16 wherein the plasma chamber liner comprises a plurality of segments.

27. The plasma source of claim 16 wherein the plasma chamber liner comprises a hard coating on an inner surface.

28. A method of generating a plasma, the method comprising:
a) containing a process gas in a plasma chamber having metal walls;
b) coupling a RF signal through a dielectric window to excite and ionize the process gas, thereby forming a plasma in the plasma chamber; and
c) providing line-of-site shielding of the inside of the plasma chamber from metal sputtered by ions in the plasma striking the metal walls of the plasma chamber so that metal ions are not sputtered into the process chamber.
